(19) United States
(12) Patent Application Publication
(10) Pub. No.: US 2020/0338565 A1
(43) Pub. Date: Oct. 29, 2020

(54) TEST RECEPTACLE RACK

(71) Applicant: The Francis Crick Institute Limited, London, Greater London (GB)

(72) Inventor: Christoph Yves SADÉE, London, Greater London (GB)

(21) Appl. No.: 16/771,329

(22) PCT Filed: Jan. 8, 2019
(86) PCT No.: PCT/GB2019/050035

§ 371 Date: Jun. 10, 2020

(30) Foreign Application Priority Data
Jan. 26, 2018 (GB) 1801325.0

(51) Int. Cl. B01L 9/06; H01F 7/02; G01N 35/00; B01L 7/04; B03C 1/28; B03C 1/01; B03C 1/033

(52) U.S. Cl. CPC B01L 9/06; H01F 7/02; G01N 35/0098; B01L 7/04; B03C 1/288; B03C 2201/26; B03C 1/0332; B01L 2400/043; B01L 2200/0631; B03C 2201/18; B03C 1/01

(57) ABSTRACT

A test receptacle (2) rack comprises apertures (6) for receiving test receptacles, each aperture having a first side and a second side opposite the first side; permanent magnets (4, M1-M6), and an (actuator 16) to impart relative motion between the permanent magnets and the apertures (6) to switch between a first configuration and a second configuration. For a given aperture (6): in one of the first configuration and the second configuration, one of the permanent magnets is positioned adjacent to the first side of the aperture, in the other of the first configuration and the second configuration, a different one of the permanent magnets is positioned adjacent to the second side of the aperture. This is useful for many lab experiments involving magnetic beads placed in receptacles.

The present technique relates to the field of laboratory tools. More particularly it relates to a test receptacle rack.

Magnetic beads can be a useful tool for many scientific experiments, in particular, in the field of molecular biology. For example, the magnetic beads can be coated in a ligand which bonds to a target substance to be separated or purified from a liquid sample in a test receptacle, such as a test tube. By applying magnetic fields to the test receptacle, the beads can be drawn to one side of the test receptacle to wash the beads through the fluid. After a number of such washing steps it is likely that the target substance may be bonded to the beads while other unwanted substances may remain in the fluid. While the beads remain trapped by the magnet, the remaining fluid can then be drawn off (e.g. by pipetting), separating the target substance from the fluid. Further experiments or procedures can then be performed on the separated/purified substance. However, with current laboratory tools such washing of magnetic beads can be a time consuming and onerous task.

At least some examples provide a test receptacle rack comprising: a plurality of apertures for receiving test receptacles, each aperture having a first side and a second side opposite the first side; a plurality of permanent magnets; and an actuator to impart relative motion between the permanent magnets and the apertures to switch between a first configuration and a second configuration, in which for a given aperture: in one of the first configuration and the second configuration, one of the permanent magnets is positioned adjacent to the first side of the aperture; and in the other of the first configuration and the second configuration, a different one of the permanent magnets is positioned adjacent to the second side of the aperture; and the actuator is configured to impart relative motion between the permanent magnets and the apertures to switch to a third configuration in which, for the given aperture, a position and orientation of each of the permanent magnets is such that a magnetic field strength at the aperture location is less than in the first configuration or the second configuration.

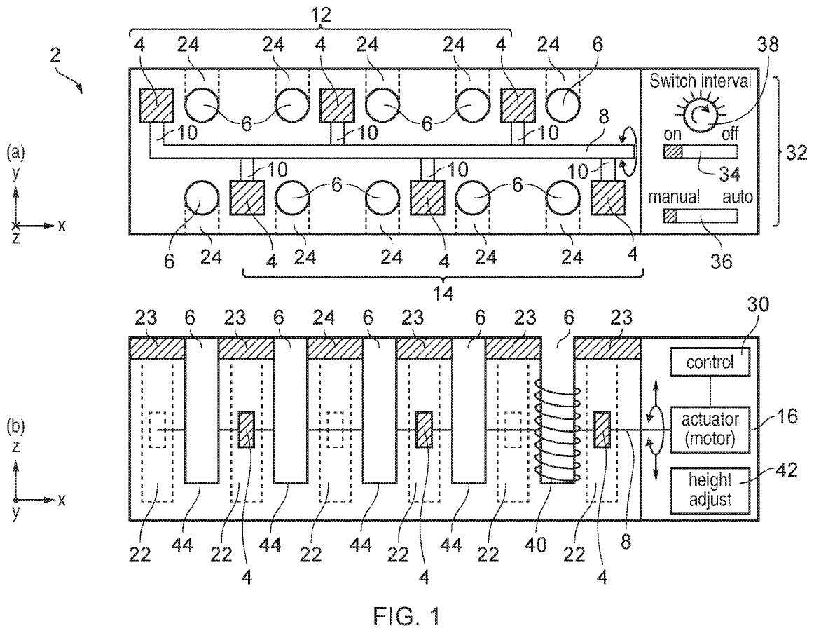

FIG. 1 shows top and side views of a test receptacle rack according to one example;

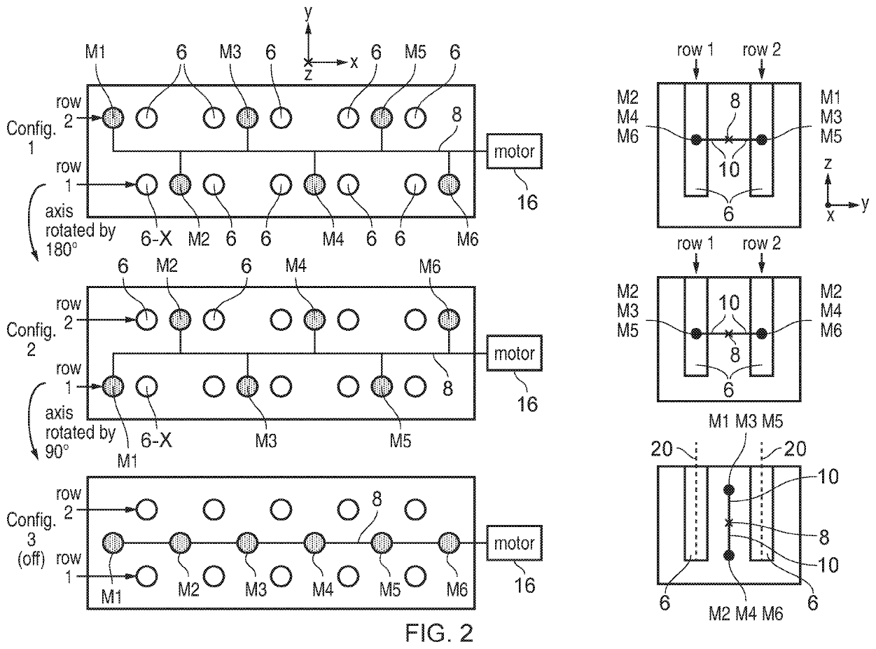

FIG. 2 illustrates first, second and third configurations of the test receptacle rack in which permanent magnets are moved relative to apertures for receiving test receptacles;

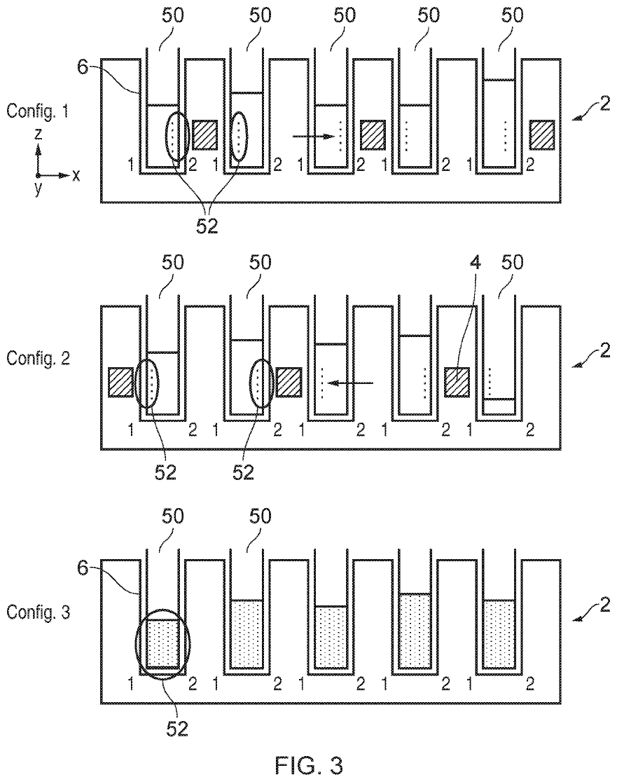

FIG. 3 shows a side view of the rack illustrating the position of magnets relative to a row of apertures in the first, second and third configurations;

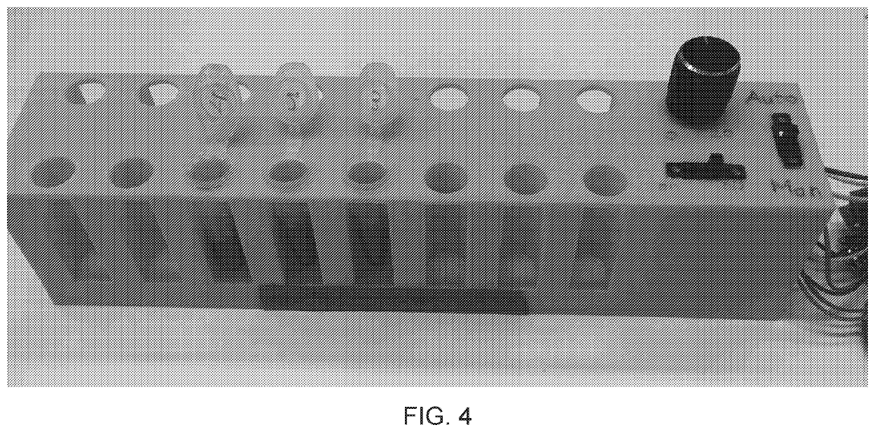

FIG. 4 is an image of prototype version of the rack illustrated in FIGS. 1 to 3;

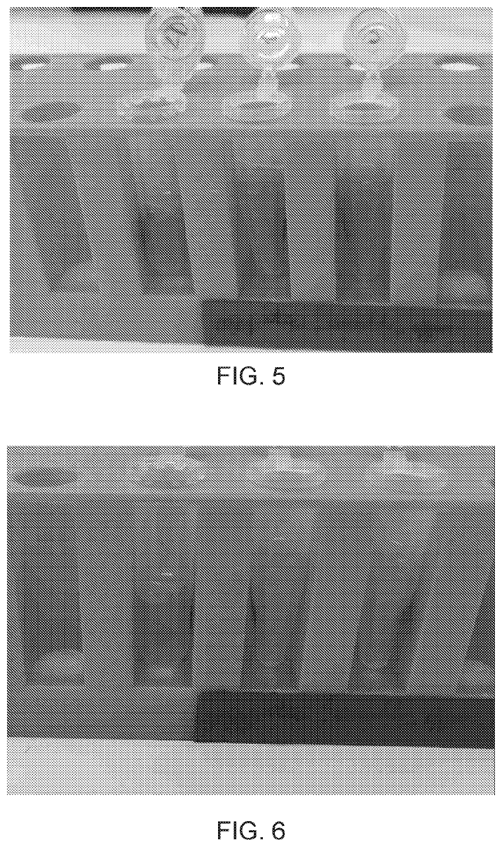

FIGS. 5 and 6 show side views of test receptacles held in the rack of FIG. 4 with the magnets placed in the first and second configurations respectively; and

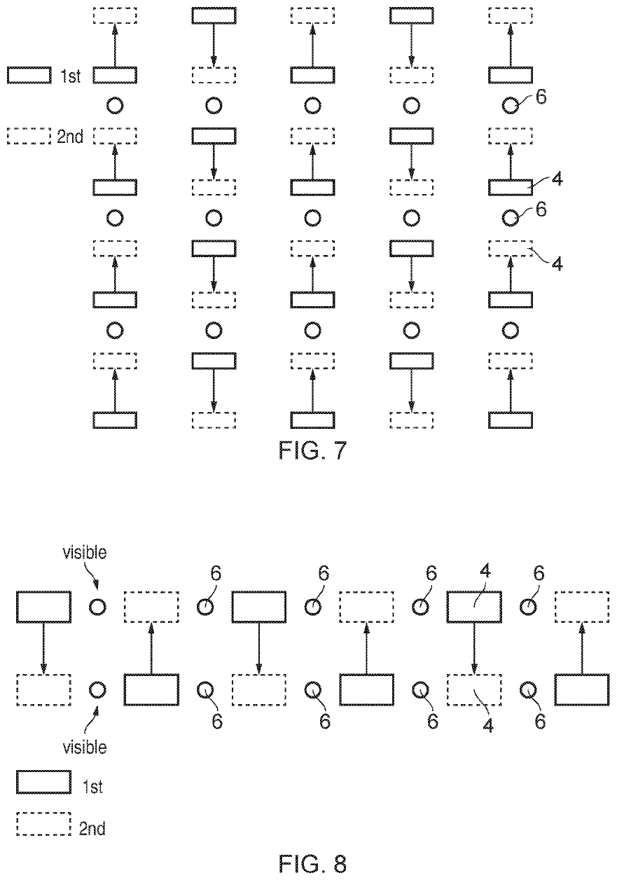

FIGS. 7 to 11 illustrate alternative ways of moving magnets between first and second configurations.

One approach for enabling washing of magnetic beads held in test receptacles can be to provide a test receptacle rack in which a number of apertures are provided and a permanent magnet is fixed in a stationary location relative to one side of the apertures, so that when a test receptacle is placed in the aperture then any magnetic beads within the test receptacle may be drawn to the side of the test receptacle. The scientist can then lift up the test receptacle and turn it around 180 degrees and reinsert it into the aperture the other way round, so that the magnet is now positioned on the opposite side, drawing the magnetic beads across the fluid. By repeatedly lifting up the test receptacle and turning it around, the magnetic beads can therefore be drawn back and forth, to wash the beads through the fluid to increase the chance that the target substance will become attached to the beads. However, this approach means that the experiment will take a relatively long time since the scientist has to keep lifting up the receptacles and turning them around and needs to do this separately for each individual receptacle in the rack.

With the test receptacle rack discussed below, the rack has a number of apertures each having a first side and a second side opposite the first side. A number of permanent magnets are provided and an actuator is provided to impart relative motion between the permanent magnets and the apertures to switch between a first configuration and a second configuration. For a given aperture, in one of the first and second configurations, one of the permanent magnets is positioned adjacent to the first side of the aperture and in the other of the first and second configurations a different one of the permanent magnets is positioned adjacent to the second side of the aperture.

Hence, by providing an actuator to impart relative motion between the magnets and the apertures, the rack can automatically switch the side of the aperture at which a magnet is positioned, without needing to actually rotate the test receptacle within the aperture. This enables faster washing and less work for the scientist, greatly speeding up many common experiments that are performed in the lab, especially in the field of medicine or molecular biology.

In particular, the relative motion between the magnets and the apertures is such that the magnet positioned to the first side of a given aperture in one of the first and second configurations is a different magnet to the magnet which is positioned adjacent to the second side of the aperture in the other of the first and second configurations. An alternative approach would be to provide a single magnet which rotates about the axis of the aperture, so that the same magnet moves from one side of the aperture to the other. However, this would imply that the magnet has to travel around the outside of the aperture, revolving around the test receptacle, which may lead to the magnetic beads being dragged along the wall of the test receptacle, which may causes shearing forces and improper binding between the magnetic beads and the target substance to be attached to the beads. In contrast, by providing a form of motion between the magnets and the apertures such that the magnet which is positioned next to the first side of the aperture in one configuration is a different magnet to the one that is positioned adjacent to the second side of the aperture in the other configuration, this avoids this problem, because different magnets appear on either side of the receptacle in the two configurations, so on switching configurations the magnetic beads are dragged back and forth across the test receptacle instead of being dragged around the circumference of the wall of the receptacle. Hence the rack can provide less damage to the substance to be separated or purified or to the beads themselves.

In some examples enough magnets could be provided so that for every aperture there are two dedicated magnets assigned to that aperture, distinct from the magnets assigned to any other aperture with the actuator moving the magnets and apertures relative to each other so that in the first configuration one of the two corresponding magnets is next to the first side of the aperture and in the second configuration the other of the corresponding magnets is next to the aperture.

However, the cost of manufacturing the device can be reduced if at least some magnets are shared between apertures. Hence at least one of the permanent magnets may be positioned adjacent to at least one aperture in the first configuration and positioned adjacent to at least one different aperture in the second configuration. That is, the actuator may either move a given permanent magnet between one aperture and another, or may move the apertures relative to the magnets to achieve the same effects. This can help to reduce the number of magnets required.

Also, in some embodiments in at least one of the first and second configurations, at least one of the permanent magnets may be positioned adjacent to the first side of one aperture and adjacent to the second side of another aperture. That is, the same magnets may effectively draw magnetic beads both to the first side of one aperture and to the second side of another aperture. Again, this can reduce the number of different magnets required as it is not necessary to provide a permanent magnet for every aperture.

Hence, in some examples the number of permanent magnets may be less than the number of apertures. On the other hand, other examples may prefer to provide a greater number of magnets, or in some cases to provide sufficient magnetic field strength then magnets may be doubled or tripled up so that several magnets together provide the effects required to draw the magnetic beads to one side of a given aperture. Nevertheless, if the number of permanent magnets can be less than the number of apertures then this may reduce manufacturing costs.

The relative motion between the magnets and the apertures could in some cases be provided by moving the apertures relative to stationary magnets. For example the apertures for receiving test receptacles could be implemented on a conveyor like apparatus or some other way of shifting the positions of the apertures could be implemented.

However, in many cases it may be simplest if the actuator moves the permanent magnets relative to stationary apertures when switching between the first and second configurations. This can be cleaner to implement, and also this may mean that the test receptacle rack may more closely resemble a standard test tube rack not having any in-built means for applying magnetic fields, which would already be familiar to a lab scientist. Also, by not moving the apertures, this can make it easier for the scientist to keep track of which sample is in which position within the test receptacle rack, which may make running experiments simpler. Nevertheless, in some examples moving apertures could still be possible.

The apertures may be formed within a housing. For example the housing could be formed out of wood or plastic, for example moulded plastic, or a material formed by additive manufacture (3D printing). The magnets may be hidden within the housing so that they are not visible from outside the rack. This may provide a cleaner appearance and also protect any moving part inside the rack from dirt or physical knocks which could damage the mechanism and allows for easy portability of the device.

For at least one of the apertures, a viewing side of the aperture between the first side and the second side may be visible from outside the housing and the viewing side may be unobscured by a path taken by the permanent magnets between the first configuration and the second configuration. Being able to see inside a given test receptacle can be important for certain types of lab experiments, for example if the experiment requires manual pipetting of fluid into the receptacle or drawing off of fluid from the receptacle by manual pipetting. While with the alternative approach discussed above where magnets revolve around the aperture, it would not be possible to leave a visual side view into the test receptacle, with the approach discussed above where a different magnet appears on either side of the aperture in the first and second configurations, this can leave a viewing window in between which may stay visible regardless of the positions of the magnets.

It can be useful to provide a rack in which the actuator also supports imparting relative motion between the magnets and the apertures to switch to a third configuration in which, for said given aperture, a position and orientation of each of the permanent magnets is such that a magnetic field strength at the aperture location is less than in the first configuration or the second configuration. More particularly, in the third configuration the position and orientation of each of the permanent magnets may be such that the magnetic field strength at the aperture location is less than a predetermined threshold. The threshold may be such that magnetic beads placed in receptacles in each aperture are not attracted towards one side of the receptacle when the rack is in the third configuration. Different models of rack designed for different sized receptacles could use different thresholds.

Hence, effectively, the third configuration may be an “off” configuration in which the magnetic particles within the test receptacle would not be drawn to any particular side of the receptacle but may instead diffuse through the fluid, so that it becomes possible to remove the magnetic particles from the test receptacle for example by drawing off the liquid in a pipette, or to resuspend the magnetic particles by pipetting up and down without beads being dragged to one side of the receptacle. This would not be possible without removing the test receptacle entirely in the alternative approach discussed above where magnets revolve around the aperture, as in this alternative the magnet would always be on one side of the aperture and cannot be moved further away. Hence, by providing a third configuration which removes the magnets from the aperture so that beads can be re-suspended, this may support a much wider range of experiments within the rack, and make it unnecessary to remove the receptacle to a different rack solely to enable re-suspending of the beads in the fluid, reducing the number of different racks required on the work bench and hence streamlining the experimental procedure.

The third configuration could be implemented in different ways. In some cases, magnets may be moved further away from the apertures when in the third configuration than when in the first/second configurations, so that the magnetic field strength is reduced. It is also possible to reduce the magnetic field strength at the aperture location by adjusting an orientation of the magnets relative to the aperture, to change the position of the poles of the magnets so that the peak magnetic field strength is no longer at the location of the aperture. A combination of changing position and orientation can also be used to reduce the magnetic field strength at a given aperture location in the third configuration.

It will be appreciated that there are a wide variety of ways in which the actuator could implement the relative motion between the apertures and the magnets. For example a range of different means of imparting the motion can be used. For example an electromagnetic motor could be provided to rotate a rotor which causes magnets to change position relative to the apertures. Also, solenoids could be provided to provide for linear sliding of magnets and/or apertures. Another approach could be to provide a gas-driven piston which could push magnets up and down relative to apertures. In many cases providing an electromagnetic motor may be most efficient. Nevertheless any other way of moving the magnets or the apertures can be used.

In one example, the apertures may be arranged in a grid pattern and the actuator may move the permanent magnets within corridors to extend between the apertures along a row or column direction of the grid pattern (it will be appreciated that the definition of which direction of the grid is a “row” and which is a “column” may be arbitrary, so rows and columns can be regarded as equivalent in this context—in general the corridors extend parallel to one of the row and column directions). This approach can be particularly useful because it enables the magnets to stay in position within their corridors so that they do not move out of line from one row/column to the next, leaving a region in between adjacent corridors across which the magnets do not pass. This can therefore enable the provision of a viewing window into a test receptacle because the magnets will not pass across that face of the test receptacle which has the benefit of making manual pipetting and other procedures easier to perform for the lab scientist.

In one particular embodiment, the apertures may include at least a first row and a second row of apertures. Some implementations could also have third, fourth or further rows, but in general the first and second rows of apertures may be any two adjacent rows of two or more rows of apertures. Again, the rows could equally well be called “columns”—no particular distinction between rows and columns is intended here. A drive rod may be provided which extends parallel to the row direction between the first and second rows of apertures. The permanent magnets may be attached to spindles extending outwards from the drive rods, and the spindles carrying a first subset of the magnets may be attached to the drive rod at a different angle about the axis of the drive rod to the spindles carrying a second subset of magnets. The actuator may switch the permanent magnets between the first configuration and the second configuration by rotating the drive rod about its axis. Also, where a third configuration is also supported then rotating the drive rod to a different angle may also switch the system to the third configuration.

This approach can be extremely efficient to implement because it means that the movement of the magnets associated with the first and second rows of apertures between the first configuration and the second configuration can be carried out using only a single motor or other actuator for causing the rotation of the drive rod. In the first configuration, the spindles carrying the first subset of magnets may point towards one of the first and second rows while the spindles carrying the second subset of magnets may point towards the other of the first and second rows. By rotating the drive rod about its axis, the magnets pointing to the first and second rows may be switched so that they now point to the opposite row, therefore causing the change between the first and second configurations in terms of which side of a given aperture a particular magnet appears at.

In one example, the first subset of magnets may be interleaved with the second subset of magnets at alternating positions along the axis of the drive rod. Hence, when in a given one of the first/second configurations, the spindles carrying the magnets may alternate pointing towards one row, then the other, then the first row again, then the second row and so on.

For example, an angular offset between the spindles carrying the first subset of the magnet and the spindles carrying the second subset of the magnets may be approximately 180 degrees. Preferably the angle may be 180 degrees exactly but it will be appreciated that this is not essential and a similar effect can be achieved with other angles. With this approach then it is relatively simple to provide a third configuration as discussed above, because as the spindles carrying the first and second subsets of magnets are approximately 180 degrees apart about the axis of the drive rods, then the drive rods can be rotated to be configured to a configuration in which all the spindles extend substantially parallel to the axis of the apertures (e.g. vertical if the apertures are arranged vertically), so that effectively the magnets are all located within a corridor partway between the first and second rows rather than being next to any particular aperture. This may adjust, the distance of the magnets and/or the orientation of the poles of the magnets relative to the apertures so that the magnetic field strength at the aperture locations is no longer strong enough to attract any magnetic beads to the side of test receptacles within the apertures, effectively providing the “off” configuration. On the other hand, if the drive rod is rotated by (e.g. by approximately 90 degrees) relative to the third configuration then this may restore the first configuration or the second configuration in which magnets are positioned next to the first or second side of apertures. Hence this can provide a relatively simple way of controlling the three configurations discussed above.

The control of the timing at which the actuator switches between the different configurations discussed above can be done either manually or automatically. In one example, the actuator may have a manual switching mode in which the actuator may switch between the first configuration and the second configuration (and if provided the third configuration) in response to a specific user input. For example the rack may have a switch which the user can operate to trigger the rack to switch to a given one of the first, second, or third configurations as required.

On the other hand, the actuator could also have an automatic switching mode in which the actuator may automatically switch between the first and second configurations at intervals of a given predetermined time, independent of whether any user input is received. For example, when placed in the automatic switching mode the actuator could switch between the first and second configurations at intervals of a certain number of seconds in order to continuously wash magnetic beads through the fluid, as the beads are dragged back and forth across the test receptacle each time the actuator switches between the first configuration and the second configuration. The predetermined time defining the interval with which the actuator switches between the first and second configurations could be configurable by a user, for example by providing a dial or other type of control for defining the switch interval. Alternatively, some racks could simply fix the switching intervals at a certain default predetermined time without allowing the user to configure the time. However, providing a configurable switching time interval can be useful for some experiments. For example, the ability to vary the switching time interval can be useful because the time taken to drag all the magnetic beads to one side may depend on the size and number of beads provided in the receptacle, and it may be desirable to ensure that all the beads have reached one side of the receptacle before switching to the opposite one of the first and second configurations, as this may provide more effective washing of the beads.

Some racks could only have one of the manual and automatic switching modes. Other racks could support both and provide a further user input for selecting which mode to operate in.

In some examples, a height adjuster may be provided to adjust a relative height at which at least one permanent magnet is positioned relative to at least one aperture when in the first configuration or the second configuration. It can be useful to provide magnets which do not extend along the full height of the receptacle when the receptacle is placed in an aperture, because if the magnets were aligned along the whole length of the test receptacle then this could result in the magnetic beads being dragged out of the fluid if only small amounts of fluid are provided within the receptacle. Also, providing magnets along the whole height of the receptacle could make manual take up of beads with a pipette more difficult because the beads would be spread out over a larger area and closer to the bottom of the receptacle. Hence, it can be desirable to provide relatively short magnets. However, in this case as different volumes of fluid may be provided, it may be useful to provide a height adjuster enabling the height of the magnets to be adjusted to match the volume of fluid in the receptacle. The height adjuster could be implemented in different ways, and could adjust the relative height between the magnets and apertures either by adjusting the position of the magnets, or by adjusting a position of the apertures. For example, the magnets themselves could be raised or lowered. Alternatively, the aperture positions could be adjusted, e.g. if the aperture includes a movable bed at the foot of the aperture which can be moved up or down, so that the test receptacle placed in the aperture can be raised or lowered as appropriate for the level of fluid provided. In some cases the height adjustment could be provided globally for all apertures. For example, in the example where the magnets are attached to a drive rod extending along a row of apertures as discussed above, the whole drive rod could be raised up or down in order to raise or lower the magnets when they are in the first or second configuration. Alternatively, individual height adjustments for particular apertures could be provided, for example with individually adjustable magnet heights, or with a movable bed controlled for a particular aperture as discussed above.

In some examples it may be useful to provide a heating or cooling element adjacent to each aperture for heating or cooling contents of a test receptacle placed in the aperture. Some forms of experiments may need to maintain the sample at a given temperature so it can be useful to provide for heating or cooling. For example a heating coil or heat conducting material could be provided about the edge of a given aperture, or a thermal electric cooling cell could be provided. For example, all apertures could be at least partially encased in a heat conducting sheath, and each sheath could be connected to a shared cooling or heating element to provide the heat sink or heat source for cooling or heating all the apertures. For example, the sheath could be made of aluminium or another material with relatively high thermal conductivity, so that the heat can flow to or from the receptacle and its contents via the sheath. An advantage of the use of permanent magnets is that they can be relatively strong even if not in immediate proximity to the edge of the aperture, so that even if a heating element or heat conducting material is provided between the magnet and the test receptacle, the magnet may still be strong enough to draw the magnetic beads to one side of the receptacle.

The test receptacle rack may be portable. The techniques discussed above may be particularly useful for a portable rack as the use of permanent magnets and a relatively simple mechanical drive for moving the magnets relative to the apertures can be relatively cheap to implement without requiring heavy machinery or complicated electromagnet arrangements or cooling devices. While more complex arrangements could be effective at a larger scale such as that used for industrial applications, many such industrial solutions would not be appropriate for a small test receptacle rack designed for use on a table top or lab bench by a scientist performing manual pipetting of liquid into or out of test receptacles within the rack. With portable test receptacle racks, which are more likely to be used for manual experiments, then visible contents of the containers may be particularly important, which is why it can be useful for the magnets to simply move on either side of the apertures without passing across the viewing window into the receptacle as discussed above.

The rack may be designed for use with any type of test receptacle. In particular the test receptacles may be test tubes (and so the rack may be a test tube rack). In some cases, the apertures may be relatively long in the vertical axis and narrower in the horizontal dimension (e.g. tubular) and in some cases tapered to either end or both. The cross-section of the receptacles could be circular, elliptical or oval, square or rectangular, or irregular. The test receptacles or test tubes do not need to have a uniform cross section and could narrow or widen along their axis. For example, it is common in the lab environments to use Eppendorf tubes which narrow towards the bottom. Alternatively, rather than a rack for use with test tubes, it would also be possible to provide a rack which has shorter apertures designed for receiving shallower dishes where the horizontal diameter is greater than the vertical height of the dish. If the diameter is small enough then it may still be practical to provide magnets which move into position on either side of the dish. Hence it will be appreciated that the test receptacle can be any container in which a sample (fluid or non-fluid) can be placed. Note in some cases magnetic particles or beads can also be useful for procedures involving powdered or fine granular media stored in the receptacles, e.g. with magnetic particles suspended in silica powder or other powder. The same rack can be used regardless of whether the sample is a fluid or non-fluid.

It can be particularly useful to use permanent magnets for drawing magnetic beads to one side or other of the container, rather than using electromagnets. In order to enable appropriate experiments to be performed, magnets of a certain strength may be needed. Not only may the magnets need to be strong enough to pull magnetic beads to one side of the receptacle, but it is also desirable for the beads to be retained in place by the magnets if liquid is taken up from the receptacle by a pipette. The meniscus of the liquid and its surface tension may attempt to drag down beads when liquid is drawn out from the receptacle and the surface of the liquid lowers. At this point it is desirable that the beads remain held at the side of the receptacle at the locations of the magnets, so that all of the liquid can be removed without removing the beads in order to achieve the separation or purification of the sample. With permanent magnets it can be relatively simple to provide strong enough magnets to enable this functionality. However, with electromagnets this could be relatively difficult when implementing a portable rack for which the size restriction may make it difficult to provide strong enough electromagnets. This is because electromagnets formed by a current carrying wire extending about a ferrous core would heat up when the current is supplied and so this may require active cooling. Hence, to achieve enough magnetic force to retain the magnetic beads in place when liquid is drawn out, either the electromagnet has to be of a considerable size, which would increase the spacing between apertures so that the rack is no longer portable anymore, or if smaller electromagnets are used then the current which would have to be supplied through the wire would have to be very high which would result in excessive heat production within a small space, which can be dangerous (for example in biological experiment working easy degradeable biomass) and also the active cooling may then increase the expense of the rack, power consumption and size and/or weight of the rack. Also, if electromagnets are used rather than moving permanent magnets, then this may require each aperture to have an individual electromagnets on each side of the aperture, again exacerbating the problems with electromagnets discussed above. Given these problems, the use of permanent magnets may provide a more practical solution for implementing relatively small portable test receptacle racks.

Another disadvantage with electromagnets is that if they are constructed to be as efficient as possible, e.g. minimum size and heat production to produce just enough force to immobilize magnetic particles, then they would need to be placed as close as possible to the receptacle in the apertures (as magnetic field strength falls off with 1/r³, where r is the distance from the magnet). This brings several problems, as any direct contact between the electromagnet and receptacle could increase heat conduction and also make it impossible to displace the electromagnet along the vertical position to allow for magnetic bead attraction in different locations (height adjustment).

FIG. 1 schematically illustrates an example of a test receptacle rack 2 with inbuilt permanent magnets 4 for attracting magnetic beads to one side of test receptacles placed in apertures 6. The test receptacles are not shown in FIG. 1 (the rack can be sold as a standalone product separate from the test receptacles, so the test receptacles do not form part of the rack itself). Part a of FIG. 1 illustrates a top view of the rack 2, providing a view in the x-y plane, while part b of FIG. 1 shows a side view viewed in the x-z plane. In this example, the x and y axes point along the length and width of the rack and the z axis is aligned vertically along the height of the rack.

As shown in the top view of FIG. 1, the rack 2 in this example has two rows of apertures 6 with each row comprising five apertures. It will be appreciated that further apertures per row could be provided, and it is not essential that each row has the same number of apertures. Also in some examples three or more rows of apertures could be provided. The magnets 4 are attached to a drive rod 8 which extends parallel to the row direction between the first and second rows of apertures 6. The magnets 4 are attached to the drive rod 8 via spindles 10. The magnets 4 are divided into a first subset 12 and a second subset 14. The spindles 10 carrying the first subset 12 of magnets 4 are attached to the drive rod 8 at a different angle compared to the spindles 10 carrying the second subset of magnets. For example the spindles 10 carrying the first subset 12 of magnets may be offset by 180 degrees relative to the spindles 10 carrying the second subset 14 of magnets. Hence, when the drive rod 8 is rotated so that it is in an orientation where all of the spindles are oriented parallel to the y axis then the first subset of magnets 12 point towards the apertures 6 in one of the rows while the second subset 14 of the magnets point towards the other of the two rows. The first subset 12 of magnets are interleaved with second subset of magnets so that they are at alternating positions along the length of the drive rod 8. An actuator 16 is provided for rotating the drive rod 8 in order to switch the configuration of the magnets relative to the apertures 6. For example the actuator may be an electromagnetic motor.

FIG. 2 shows an example of three different configurations into which the magnets can be placed by rotating the drive rod 8 using the actuator 16. The left hand part of FIG. 2 shows a view of each configuration when viewed from above in the x-y plane, while the right hand part of FIG. 2 shows a view of each of these configurations when viewed along the end of the rack in the y-z plane. In this example, the first subset 12 of magnets is labelled M1, M3, M5 and the second subset of magnets 14 is labelled M2, M4, M6.

In the first configuration shown in FIG. 2, the actuator 16 has oriented the drive rod 8 so that the first subset of magnets M1, M3, M5 points towards row 2 and the second subset of magnets M2, M4, M6 points towards row 1. Hence, some of the apertures have a magnet positioned to the left hand side of the aperture while other apertures have a magnet positioned to the right hand side of the aperture. Any magnetic beads provided within the test receptacle within a given aperture may therefore be drawn to either the left hand side or the right hand side. As shown in the end view at the right hand part of FIG. 2, in the first configuration the spindles 10 of the rotor are oriented substantially parallel to the y axis (perpendicular to an axis of the tubular apertures 6) with half the magnets pointing to one row and the other magnets pointing to the other row.

As shown in the second configuration shown in FIG. 2, by rotating the drive rod 8 by 180 degrees, the motor 16 can flip the orientation of the magnets so that the magnets, M1, M3, M5 which were pointing towards the second row in the first configuration now point towards the first row and the magnets M2, M4, M6 which were pointing towards the first row now point towards the second row. Hence, this flips which side each aperture 6 a magnet is nearest to. Those apertures 6 for which a magnet was on the left hand side in the first configuration now have a magnet on the right hand side of the aperture in the second configuration, and similarly the apertures 6 which had a magnet adjacent to the right hand side of the aperture in the first configuration now have a magnet position to the left hand side of the aperture. Note that, for any given aperture 6, the magnet 4 which is positioned to the left hand side of the aperture in one of the first and second configurations is a different magnet to the magnet which is positioned to the right hand side of the aperture in the other configuration. For example, for the left hand aperture 6-X of the first row, magnet M2 is next to aperture 6-X in the first configuration and magnet M1 is next to aperture 6-X in the second configuration. For all the other apertures, the same is true—the magnet next to the aperture in the first configuration is different to the magnet next to that aperture in the second configuration. This is useful because sliding or moving different magnets into position in the respective configurations means that it is not necessary to rotate a single magnet around the outside of the aperture which would have the effect of dragging any magnetic beads around the inner wall of the test receptacle placed in the aperture, which could lead to damage of the beads or the substance attached to the beads.

Another benefit of this approach is that the same magnet can be positioned near two different apertures at once reducing the number of magnets required. For example magnet M3 is positioned on the right hand side of one aperture and on the left hand side of another aperture simultaneously. Also, for any particular magnet, such as M3, the magnet moves from one row to the other between the first and second configurations, shared between multiple rows to avoid the need for dedicated magnets for each row. Also this approach makes it simple to transpose the positions of the magnets using only a single motor, since the motor can simply rotate the drive rod 8 in order to swap the positions of the magnets.

As shown in the third configuration at the bottom of FIG. 2 if the drive rod 8 is rotated by 90 degrees relative to either the first configuration or the second configuration then this means that the spindles 10 connecting the magnets to the drive rod 8 are now oriented vertically parallel to the z axis and also parallel to the axis 20 of the apertures. This means that all of the magnets 4 now move away from the apertures and are positioned equidistant between the apertures within a gap between the adjacent rows of apertures 6. Also, the orientation of the poles of the magnets may be adjusted so that the direction in which the magnetic field is most strongly applied now points towards/away from the motor parallel to the drive rod 8, instead of towards the apertures. Therefore, the third configuration may be effectively provide an “off” configuration in which no attraction of magnetic beads occurs. This can be very useful for enabling the beads to be resuspended in the solution.

Returning to FIG. 1, as seen in the side view in part b of FIG. 1, the rotation of the magnets may take place within certain linear corridors 22 which extend in the gaps between the apertures 6. That is, the magnets themselves rotate about the axis of the drive rod 8, but each magnet has freedom of movement within a corresponding one of the linear corridors 22. In part b of FIG. 1 some of the magnets 4 are shown in solid lines and others in dotted lines to reflect the fact that the solid magnets are closer to the viewer then the magnet shown in dotted lines. The magnets themselves may not be visible from the outside of the housing of the rack. Also, the corridors 22 may be hidden within the inside of the housing. In some cases the apertures 6 may be bounded by solid material extending along the entire length of the apertures. However another approach may be simple to provide some solid material at the top of each aperture as shown in the shaded portion 23 of the housing shown in part b of FIG. 1, and then this material at the top of the rack may be enough to support receptacles dangling into the centre of the rack even if there is no solid material extending along the entire length of the test receptacle when it is suspended from the support at the top of the rack. Therefore it will be appreciated that it is not essential for the apertures to be the same length at the test receptacles. However, providing guide material along the length of the aperture can in some cases provide greater protection against a chance of receptacles being knocked by the moving parts inside the housing, which might be a risk if the receptacles were free to dangle and so the receptacles could be aligned at different angles from the axis of the aperture.

A benefit of controlling the motion of the magnets 4 so that they only move within linear corridors 22 extending parallel to a row or column direction of a grid of apertures, but do not pass between rows or between columns, can be that this can retain a viewing window 24 through which the side of the test receptacle can still be visible. There is no magnet which will then traverse across the viewing window 24 obscuring the visible side of the test receptacle. The viewing windows 24 are indicated in part a of FIG. 1. Leaving such viewing windows 24 clear would not be possible, for example, if a single magnet revolved about the axis of the apertures from side to side so that the same magnet applies the force to a given aperture in both the first and second configurations.

As shown in FIG. 1, the rack may include a control unit 30 for controlling the switching between the different configurations by the actuator 16. The control unit 30 may be controlled based on user input supplied via a user input interface 32. The user input interface 32 could be provided with one or more mechanical switches to be operated manually by the user, or as an electronic display which may display virtual switches or buttons which the user can use to instruct the control unit 30 to control the actuator 16.

In this example the user input interface 32 includes an on/off switch 34, a mode switch 36 and a time interval control 38. Regardless of whether in the manual mode or the automatic mode, when the on/off switch 34 is switched to the off position, then the control unit 30 controls the actuator 16 to rotate the drive rod 8 so that the magnets are oriented in the third configuration shown in FIG. 2 so that there is no attraction of beads to one side of the receptacles.

The mode switch 36 controls whether the rack 2 is operating in a manual switching mode or an automatic switching mode. In the manual mode, switching between the first, second and third configurations is triggered by the user switching the on/off switch 34. When the user switches the on/off switch 34 to the on position then the control unit 30 controls the actuator 16 to rotate the drive rod by 90 degrees (relative to the third configuration) to one of the first and second configurations. By repeatedly switching on and off the on/off switch 34, the control unit 30 alternates which of the first and second configurations is selected for each time the on/off switch is switched to the on position. For example, the first time the switch is switched to the on position, the first configuration could be selected, but the next time the switch returns to the on position then the second configuration could be selected, and then the third time the switch returns to the on position then the first configuration could be selected again, and so on. This approach can be simple to implement because each time the on/off switch 34 is switched between the on and off positions, the motor 16 may rotate the drive rod 8 by 90 degrees in a certain direction. Hence, in some examples the control signal provided to the motor may be exactly the same regardless of whether the switch is being switched to the on position or the off position, as it may simply instruct a rotation by 90 degrees each time it is switched either way and this may cycle between the first configuration, then the third configuration, then the second configuration, then the third configuration again (as there are two different versions of the third configuration when either the first subset of magnets are pointing upwards and the second subset pointing downwards or vice versa). Alternatively, in other examples a 180 degrees servo motor could be used, for which rotation is limited to 180 degrees, and in this case rotation would happen back and forth in 90 degree intervals, rather than rotating continuously in one direction across the full 360 degrees as discussed above.

It will be appreciated that in other versions of the rack, a dedicated switch for selecting a particular one of the first configuration or the second configuration could be provided, so that the user may separately instruct each configuration regardless of which configuration was selected the last time the on/off switch was operated. However, in practice providing such additional switches and control circuitry may be unnecessary since most of the time a user would be likely to simply want the magnets to alternate between positions in order to trigger the magnetic beads to be drawn backwards and forwards across the receptacles for washing. Hence, it may be unlikely that the user would want to select the same one of the first/second configurations on two successive occasions. Hence, by providing a single combined on/off switch which allows the first and second configurations to be selected alternately, this can reduce the complexity of the user interface and the control unit 30.

Hence in the manual mode the motor is activated each time the user operates the on/off switch 34. If the user leaves the on/off switch in the same position for a time, then no switching will occur until the next time the user switches the on/off switch 34.

In contrast, if the mode switch 36 is switched to the automatic mode then, when the on/off switch is switched to the on position, the control unit 30 controls the motor 16 to repeatedly switch between the first and second configurations at intervals of a given time. The length of the switching intervals may be controlled using the time interval control 38 so that the user can vary the frequency with which the magnets will switch between the first and second configurations. Hence, each time the interval set by the time interval control 38 elapses, the control unit 30 controls the actuator 16 to rotate the drive rod 8 by 180 degrees so as to flip to the opposite one of the first and second configurations. This means that the magnets will repeatedly be switched to opposite sides of each aperture, so that the magnetic beads inside any receptacles will be washed by moving back and forth across the receptacle through the fluid.

Other examples of the rack may not provide the mode switch 36, and could always operate in one of the manual or automatic switching modes. Even if only an automatic switching mode is supported, the on/off switch 34 may still be provided to trigger whether the system enters the automatic switching between the first and second configurations in the on position or is returned to the third configuration in the off position. It will be appreciated that the particular representation of the switches and controls in FIG. 1 is just one example—any type of user input interface which can accept input from the user could receive the same pieces of information (switching mode, on/off selection, and/or time switching interval). Also, it will be appreciated that additional controls could also be provided to adjust other aspects relating the magnet position, such as magnet orientation.

As shown in part b of FIG. 1, optionally a heating and cooling element 40 can be provided around each aperture. For conciseness, the heating element 40 is only shown for one aperture but it will be appreciated that every aperture could have such a heating/cooling element or alternatively only a subset of apertures could be provided with the heating element. For example, the heating element could be an electrical coil extending about the aperture (or partially encasing the aperture to leave the viewing window unblocked by the coil), and when current is supplied through the coil will heat the contents of the aperture. Alternatively cooling elements could be provided at each aperture to enable cooling of the contents of the receptacles placed in the aperture.

An alternative heating and cooling element implementation can be given by encasing every aperture 6 in a half enclosure (to allow for view into tubes) by a heat conductive material which is connected at the base of each aperture to each other aperture forming a heat conductive base plate (below the driving rod and spindles). The conductive base itself may then have a single cooling and heating element (e.g. Peltier cooler) which would allow for cooling and heating. The whole system may be wrapped in a plastic casing for safety, and no direct contact with heating element and or hot part would be ensured in this way. Cooling may require active heat displacement, which is easily achieved with a heat sink and fan set up below the conductive plate.

Also, a height adjustment control 42 may be provided. For example, the user may be able to control the actuator 16 to change the height at which the drive rod 8 is positioned, so that magnets can be moved up and down relative to the apertures. Another way of implementing the height adjustment can be to provide a control unit which can raise or lower the bed 44 of each aperture so that a test receptacle within the aperture can be raised up or dropped down relative to the magnets so as to change the height at which the magnets are positioned relative to the test receptacle.

FIG. 3 shows a view of the rack 2 in the first, second and third configurations respectively, when test receptacles 50 are inserted into each aperture 6. Each receptacle 50 in this example is a test tube, although other forms of receptacle could be supported for some racks. Each receptacle 50 includes fluid containing a number of magnetic beads 52. In this example, the left hand side of each aperture 6 is regarded as a first side and the right hand side is regarded as the second side. In the first configuration, the beads in some of the apertures are drawn towards the first side and in other apertures are drawn towards the second side. This is flipped in the second configuration when the magnets are on the opposite side for each aperture. In the third configuration, the magnets are placed at positions/orientations so that, at the location of the apertures, the magnetic field strength is less than a threshold (and less than in the first or second configurations), so that the force is too weak to draw the beads 52 towards any particular side of the apertures or receptacles, and so this time the magnetic beads re-suspend throughout the fluid within each receptacle 50.

Hence, as shown by the arrows shown for the third aperture in FIG. 3, the beads may be repeatedly drawn to the right and to the left by alternating switching between the first and second configurations (in either the manual or automatic switching mode). As shown in the right hand aperture in the example of configuration 2, if having performed a number of washing cycles, fluid is then drawn out of a given test receptacle 50 so that the fluid level drops below the position of the nearest magnet 4, the magnetic beads may still be retained near the side wall of the receptacle 50 so as to be separated from the rest of the fluid. Hence once all of the fluid has been drawn off, this may allow the separated substances which have been retained on a side wall by the magnets to be used for other experiments or procedures or further processing with other liquid in the same tube.

FIG. 4 is an image of a prototype of the rack shown in FIGS. 1-3. The housing of the rack may be made from plastic, for example by 3D printing or other additive manufacturing techniques or by moulding or any other manufacturing process. It will be appreciated that a similar housing could be formed out of wood or any other material. Additional elements of different material may be included in part of the housing if needed, e.g. a conducting backwall for the heating/cooling element as mentioned above—in this case most of the walls could be plastic/wood but the backwall could be conductive material (e.g. aluminium or other metal) for example.

As is clear from the image in FIG. 4, the magnets are all hidden within the inside of the housing and are not visible to the user. If provided, the heating/cooling element(s) may also be hidden within the housing (other than the conductive material directly in contact with the tube). Each magnet moves within a linear corridor inside the housing, between the apertures. Also it is clear from the image of FIG. 4 that each aperture has a viewing window through which the user can see the contents of the test receptacle placed in the aperture. FIGS. 5 and 6 show images of the rack in use, when the magnets are in the first or second configuration respectively. As can be seen in the images, the magnetic beads are drawn to opposite sides of the receptacles when in the second configuration compared to the first configuration.

It will be appreciated that in other embodiments the magnets can be moved between apertures than in other ways shown in FIGS. 1-3. For example FIGS. 7-11 show five alternatives. In each of these examples, rather than rotating magnets connected to a drive rod, a linear sliding of magnets relative to the apertures provided, for example controlled by pistons or solenoids. In each of the diagrams in FIGS. 7-11, the magnet positions in the first and second configurations are shown using solid lines and dotted lines respectively (and the third configuration would be mid-way between the positions shown for the first/second configurations).

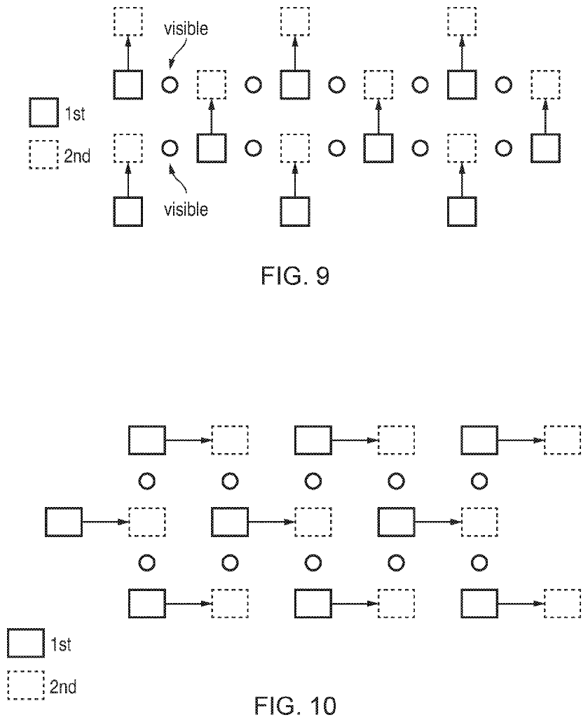

In the example of FIGS. 7 and 10, the magnet positions would obscure visibility into the receptacles placed in the apertures 6, which might be acceptable for some applications. On the other hand, the examples of FIGS. 8, 9 and 11 are similar to that of FIGS. 1-3 in that they only move the magnets 4 within linear corridors extending along a row or column of apertures in such a way that visibility into one side of the apertures is not obscured by any position of the magnet. As shown in FIGS. 7 and 8, in some examples the motion provided by the actuator 16 may provide for opposite directions of motion for certain subsets of magnets so that some magnets move down when moving from the first to the second configuration and other magnets move up. However this may require individually provided linear actuators for each of the two directions. In contrast, in the examples of FIGS. 9 and 10 all of the magnets move in the same direction when switching from the first configuration to the second configuration, which could be simpler to implement as all the magnets could for example be connected to a common drive mechanism which may implement the shifting of all the magnets. However the approaches of FIGS. 9 and 10 may require additional space at one end of the rack to accommodate the magnets once they have been slid past the last aperture. In the example of FIG. 9, the magnets move along linear corridors provided in the column direction, while in FIG. 10 the magnets move parallel to the rows.

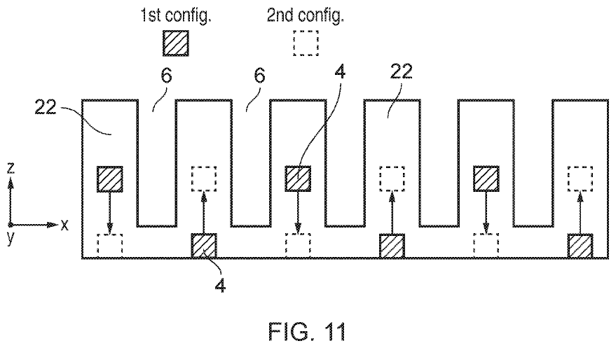

As shown in FIG. 11, another option for moving magnets relative to the apertures can be to provide magnets 4 which are movable along the z-axis to move up and down from below the apertures 6 (it will be appreciated the magnets could also move along the z-axis from above the apertures, but moving them from below may make placing receptacles in the apertures more straightforward). When a magnet is in the raised position adjacent to the apertures 6, then it attracts magnetic particles in the receptacle placed in the aperture 6 towards one side of the receptacle. When the magnet is in the lowered position, the field strength at the aperture location imparted by that magnet is less. The magnets 4 can be divided into subsets so that in a first configuration, a first subset of the magnets is raised and a second subset of the magnets is lowered, and in the second configuration, the first subset of the magnets is lowered and the second subset of the magnets is raised to flip which side of each aperture 6 the nearest magnet is located. A third (“off”) configuration can also be provided in which all of the magnets are lowered. For example, a screw mechanism could be used to drive the magnets up and down. Each magnet in the first subset of magnets could be attached to a common drive member so that they can be driven up and down by a single actuator. Similarly, each magnet in the second subset of magnets could be attached to a second drive member driven by a single actuator. Hence, by moving magnets into place along the z axis, the control unit can select between first, second and third configurations similar to those discussed above. With this arrangement, as the magnets move within linear corridors 22 extending between the apertures 6 similar to those discussed above, so that the magnets do not pass across the side of the receptacles inside the apertures 6, a viewing window into the receptacles is left clear.

It will be appreciated that many other ways of controlling the positions and/or orientation of the magnets may be provided. However in general each of the examples of FIGS. 7-11 is such that, for any given aperture, the magnet which is positioned next to that aperture in one of the first and second configurations is a different magnet to the magnet that is positioned next to the aperture in the other of the first and second configurations, which avoids the shearing forces caused by dragging magnetic beads around the inner wall of the receptacle which would be required if a single magnet had to revolve around the aperture.

Further examples are set out in the following clauses:
(1) A test receptacle rack comprising:

a plurality of apertures for receiving test receptacles, each aperture having a first side and a second side opposite the first side;

a plurality of permanent magnets; and

an actuator to impart relative motion between the permanent magnets and the apertures to switch between a first configuration and a second configuration, in which:

for a given aperture:
in one of the first configuration and the second configuration, one of the permanent magnets is positioned adjacent to the first side of the aperture; and
in the other of the first configuration and the second configuration, a different one of the permanent magnets is positioned adjacent to the second side of the aperture.
(2) The test receptacle rack of clause 1, in which:

at least one of the permanent magnets is positioned adjacent to at least one aperture in the first configuration and positioned adjacent to at least one different aperture in the second configuration.
(3) The test receptacle rack of any of clauses (1) and (2), in which:

in at least one of the first configuration and the second configuration, at least one of the permanent magnets is positioned adjacent to the first side of one aperture and to the second side of another aperture.
(4) The test receptacle rack of any preceding clause, in which the number of permanent magnets is less than the number of apertures.
(5) The test receptacle rack of any preceding clause, in which the actuator is configured to move the permanent magnets relative to stationary apertures when switching between the first configuration and the second configuration.
(6) The test receptacle rack of any preceding clause, in which the apertures are formed within a housing.
(7) The test receptacle of clause (6), in which the permanent magnets are hidden within the housing.
(8) The test receptacle rack of any of clauses (6) and (7), in which for at least one of the apertures:

a viewing side of the aperture between the first side and the second side is visible from outside the housing, where the viewing side is unobscured by a path taken by the permanent magnets between the first configuration and the second configuration.
(9) The test receptacle rack of any preceding clause, in which the actuator is configured to impart relative motion between the permanent magnets and the apertures to switch to a third configuration in which, for the given aperture, a position and orientation of each of the permanent magnets is such that a magnetic field strength at the aperture location is less than in the first configuration or the second configuration.
(10) The test receptacle rack of any preceding clause, in which the apertures are arranged in a grid pattern; and

the actuator is configured to move the permanent magnets within corridors extending between the apertures along a row or column direction of the grid pattern.
(11) The test receptacle rack according to any preceding clause, in which:

the apertures include a first row and a second row of apertures;

a drive rod extends parallel to a row direction, between the first and second rows of apertures;

the permanent magnets are attached to spindles extending outwards from the drive rod, where the spindles carrying a first subset of the magnets are attached to the drive rod at a different angle about the axis to the spindles carrying a second subset of the magnets; and

the actuator is configured to switch the permanent magnets between the first configuration and the second configuration by rotating the drive rod about its axis.
(12) The test receptacle rack according to clause (11), in which the first subset of magnets are interleaved with the second subset of the magnets at alternating positions along the axis of the drive rod.
(13) The test receptacle rack according to any of clauses (11) and (12), in which an angular offset between the spindles carrying the first subset of the magnets and the spindles carrying the second subset of the magnets is approximately 180 degrees.
(14) The test receptacle rack according to clause (13), in which the actuator is configured to rotate the drive rod relative to the first configuration or the second configuration to switch to a third configuration in which all the spindles attached to the drive rod extend substantially parallel to an axis of the apertures.
(15) The test receptacle rack according to any preceding clause, in which the actuator has a manual switching mode in which the actuator is configured to switch between the first configuration and the second configuration in response to a user input.
(16) The test receptacle rack according to any preceding clause, in which the actuator has an automatic switching mode in which the actuator is configured to automatically switch between the first configuration and the second configuration at intervals of a predetermined time, independent of whether any user input is received.
(17) The test receptacle rack according to clause (16), in which the predetermined time is configurable by a user.
(18) The test receptacle rack according to any preceding clause, comprising a height adjuster to adjust a relative height at which at least one permanent magnet is positioned relative to at least one aperture when in the first configuration or the second configuration.
(19) The test receptacle rack according to any preceding clause, comprising a heating or cooling element for heating or cooling contents of a test receptacle placed in at least one of the apertures.
(20) The test receptacle rack according to any preceding clause, in which the test receptacle rack is portable.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. A test receptacle rack comprising:
a plurality of apertures for receiving test receptacles, each aperture having a first side and a second side opposite the first side;
a plurality of permanent magnets; and
an actuator to impart relative motion between the permanent magnets and the apertures to switch between a first configuration and a second configuration, in which:
for a given aperture:
in one of the first configuration and the second configuration, one of the permanent magnets is positioned adjacent to the first side of the aperture; and
in the other of the first configuration and the second configuration, a different one of the permanent magnets is positioned adjacent to the second side of the aperture; and
the actuator is configured to impart relative motion between the permanent magnets and the apertures to switch to a third configuration in which, for the given aperture, a position and orientation of each of the permanent magnets is such that a magnetic field strength at the aperture location is less than in the first configuration or the second configuration.

2. The test receptacle rack of claim 1, in which:
at least one of the permanent magnets is positioned adjacent to at least one aperture in the first configuration and positioned adjacent to at least one different aperture in the second configuration.

3. The test receptacle rack of claim 1, in which:
in at least one of the first configuration and the second configuration, at least one of the permanent magnets is positioned adjacent to the first side of one aperture and to the second side of another aperture.

4. The test receptacle rack of claim 1, in which the number of permanent magnets is less than the number of apertures.

5. The test receptacle rack of claim 1, in which the actuator is configured to move the permanent magnets relative to stationary apertures when switching between the first configuration and the second configuration.

6. The test receptacle rack of claim 1, in which the apertures are formed within a housing.

7. The test receptacle of claim 6, in which the permanent magnets are hidden within the housing.

8. The test receptacle rack of claim 6, in which for at least one of the apertures:
a viewing side of the aperture between the first side and the second side is visible from outside the housing, where the viewing side is unobscured by a path taken by the permanent magnets between the first configuration and the second configuration.

9. The test receptacle rack of claim 1, in which the apertures are arranged in a grid pattern; and
the actuator is configured to move the permanent magnets within corridors extending between the apertures along a row or column direction of the grid pattern.

10. The test receptacle rack according to claim 1, in which:
the apertures include a first row and a second row of apertures;
a drive rod extends parallel to a row direction, between the first and second rows of apertures;
the permanent magnets are attached to spindles extending outwards from the drive rod, where the spindles carrying a first subset of the magnets are attached to the drive rod at a different angle about the axis to the spindles carrying a second subset of the magnets; and
the actuator is configured to switch the permanent magnets between the first configuration and the second configuration by rotating the drive rod about its axis.

11. The test receptacle rack according to claim 10, in which the first subset of magnets are interleaved with the second subset of the magnets at alternating positions along the axis of the drive rod.

12. The test receptacle rack according to claim 10, in which an angular offset between the spindles carrying the first subset of the magnets and the spindles carrying the second subset of the magnets is approximately 180 degrees.

13. The test receptacle rack according to claim 12, in which the actuator is configured to rotate the drive rod relative to the first configuration or the second configuration to switch to a third configuration in which all the spindles attached to the drive rod extend substantially parallel to an axis of the apertures.

14. The test receptacle rack according to claim 1, in which the actuator has a manual switching mode in which the actuator is configured to switch between the first configuration and the second configuration in response to a user input.

15. The test receptacle rack according to claim 1, in which the actuator has an automatic switching mode in which the actuator is configured to automatically switch between the first configuration and the second configuration at intervals of a predetermined time, independent of whether any user input is received.

16. The test receptacle rack according to claim 15, in which the predetermined time is configurable by a user.

17. The test receptacle rack according to claim 1, comprising a height adjuster to adjust a relative height at which at least one permanent magnet is positioned relative to at least one aperture when in the first configuration or the second configuration.

18. The test receptacle rack according to claim 1, comprising a heating or cooling element for heating or cooling contents of a test receptacle placed in at least one of the apertures.

19. The test receptacle rack according to claim 1, in which the test receptacle rack is portable.
